(19) United States
(12) Patent Application Publication
(10) Pub. No.: US 2018/0180918 A1
(43) Pub. Date: Jun. 28, 2018

(54) FORCE TOUCH LIQUID CRYSTAL DISPLAY AND METHOD OF FABRICATING THE SAME

(71) Applicants: Shenzhen China Star Optoelectronics Technology Co., Ltd., Shenzhen, Guangdong (CN); Wuhan China Star Optoelectronics Technology Co., Ltd., Wuhan, Hubei (CN)

(72) Inventors: Man LI, Shenzhen, Guangdong (CN); Xingling GUO, Shenzhen, Guangdong (CN); Zhenzhou XING, Shenzhen, Guangdong (CN)

(73) Assignees: Shenzhen China Star Optoelectronics Technology Co., Ltd., Shenzhen, Guangdong (CN); WUHAN CHINA STAR OPTOELECTRONICS TECHNOLOGY CO., LTD, Wuhan, Hubei, (CN)

(21) Appl. No.: 15/309,735

(22) PCT Filed: Aug. 4, 2016
(86) PCT No.: PCT/CN2016/093189

§ 371 Date: Nov. 8, 2016

(30) Foreign Application Priority Data
Jun. 6, 2016 (CN) 201610399266.7

(51) Int. Cl. G02F 1/1333; G02F 1/1335; G02F 1/1368; G06F 3/041; G09G 3/36

(52) U.S. Cl. CPC G02F 1/13338; G02F 1/133514; G02F 1/1368; G02F 1/133512; G06F 2203/04103; G09G 3/36; G02F 2202/28; G09G 2330/04; G09G 2300/04; G06F 3/0414

(57) ABSTRACT

A force touch liquid crystal display (LCD) and a method of fabricating the same are proposed. The force touch LCD includes: a touch panel and an LCD module. The LCD module includes a thin-film transistor (TFT) substrate, a liquid crystal layer, and a color filter substrate layered subsequently. The force touch LCD further includes a force film and a shield metal layer. The force film is formed on a surface of the touch panel, and the surface facing the LCD module. The shield metal layer is arranged on a surface of the color filter substrate. The shield metal layer can prevent the LCD display signal from being disturbed by the touch panel signal and vice versa to ensure the accuracy of display and touch.

### BACKGROUND

### 1. Field of the Disclosure

The present disclosure relates to the field of touch display, and more particularly, to a force touch liquid crystal display (LCD) and a method of fabricating the force touch LCD.

### 2. Description of the Related Art

Small- and medium-sized electronic products, such as smartphones, tablets, and televisions, have been developing in recent years. The human-machine interaction (HMI) between a person and an electronic product is not restricted to key or button operations. The tendency is that, the human-machine interaction (HMI) happens when a person clicks or touches on a display screen directly. A touch device is an interactive platform for a direct touch and an electronic product. The force touch technique is developed accordingly. A force film is a key component to realize the function of force touch. The force film is patterned with an indium tin oxide (ITO) pattern which is a specific touch force with a technique like silk screen printing. As FIG. 1 shows, a force touch thin film 120 is formed by printing a sensor array 122 on a thin film substrate 121.

As FIG. 2 shows, a conventional force touch LCD 100 includes a touch panel (TP) 131, and LCD module 132, and a backlight module 133. The touch panel 131 can be attached to the LCD module 132 tightly with an adhesive 150. The force film 120 is usually arranged on an upper surface of a middle frame (or a middle-frame bracket) of the LCD module 132. The force film 120 and a common voltage electrode in the LCD module form a pressure capacitor.

For the force touch LCD with the structure, a common electrode 134 in the LCD module 132 is required to act as another electrode of the pressure capacitor while the common electrode 134 is needed on display and some embedded touch panels. As a result, signal disturbance occurs easily. On the other hand, signal disturbance occurs between the touch panel in the above-mentioned structure and the display of the LCD module, which affects the signal-to-noise ratio (SNR) of the touch panel. Therefore, in light of defects of the related art, it is urgent to improve a touch technique to effectively reduce signal disturbance.

### SUMMARY

To solve the problems existing in the related art, a force touch LCD is proposed by the embodiment of the present disclosure. Not only signal disturbance does not occur between the force touch and the display but also the force touch quality is well improved.

According to one aspect of the present disclosure, a force touch liquid crystal display (LCD) includes a touch panel and a liquid crystal display (LCD) module. The LCD module includes a thin-film transistor (TFT) substrate, a liquid crystal layer, and a color filter substrate layered subsequently. The force touch LCD further includes a force film and a shield metal layer. The force film is formed on a surface of the touch panel, and the surface facing the LCD module. The shield metal layer is arranged on a surface of the color filter substrate.

Preferably, the touch panel is attached to the LCD module tightly with an adhesive arranged on a periphery of the touch panel, and an air layer is formed between the touch panel and the LCD module.

Preferably, a pressure capacitor is formed between the force film and the shield metal layer; the force film and the shield metal layer form two electrodes of the pressure capacitor, respectively.

Preferably, the shield metal layer is arranged on the surface of the color filter substrate and the surface faces the force film.

Preferably, the shield metal layer is arranged on the surface of the color filter substrate and the surface faces the liquid crystal layer.

According to another aspect of the present disclosure, a method of fabricating a force touch liquid crystal display (LCD) includes: forming a force film on one surface of a touch panel; stacking a thin-film transistor (TFT) substrate, a liquid crystal layer, and a color filter substrate subsequently to form an LCD module, arranging a shield metal layer on one side of the color filter substrate, and arranging the force film to face the LCD module, and attaching the touch panel to the LCD module tightly.

Preferably, the touch panel is attached to the LCD module tightly with an adhesive arranged on a periphery of the touch panel, and an air layer is formed between the touch panel and the LCD module.

Preferably, a pressure capacitor is formed between the force film and the shield metal layer; the force film and the shield metal layer form two electrodes of the pressure capacitor, respectively.

Preferably, the shield metal layer is arranged on the surface of the color filter substrate and the surface faces the force film.

Preferably, the shield metal layer is arranged on the surface of the color filter substrate and the surface faces the liquid crystal layer.

Based on the force touch LCD proposed by the embodiment of the present disclosure, signal disturbance does not happen between the force touch and the display, and the force touch quality of the LCD is enhanced as well. In addition, a shield metal layer is used as not only an electrode of the pressure capacitor but also a shield layer so the shield metal layer can prevent the LCD display signal from being disturbed by the touch panel signal and vice versa to ensure the accuracy of display and touch.

These and other features, aspects and advantages of the present disclosure will become understood with reference to the following description, appended claims and accompanying figures.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 shows a schematic diagram of a conventional force film.

FIG. 2 shows a schematic diagram of a conventional force touch liquid crystal display.

FIG. 3 is a schematic diagram illustrating a force touch liquid crystal display (LCD) according to one preferred embodiment of the present disclosure.

FIG. 4 is a schematic diagram illustrating a force touch liquid crystal display (LCD) according to another preferred embodiment of the present disclosure.

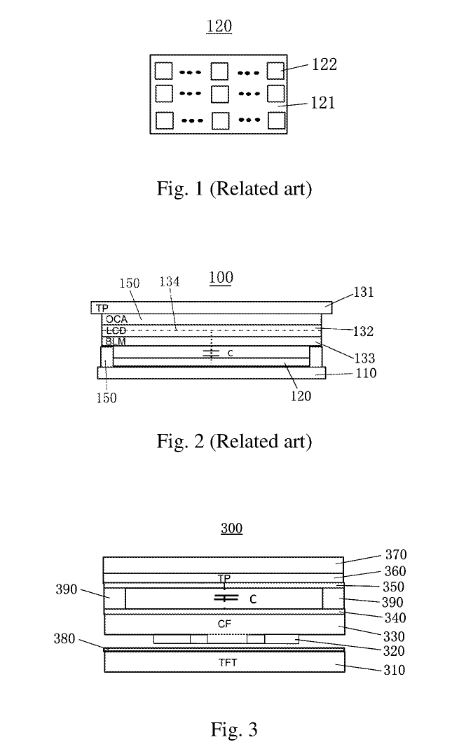

### DETAILED DESCRIPTION OF THE PREFERRED EMBODIMENTS

For better understanding embodiments of the present disclosure, the following detailed description taken in conjunction with the accompanying drawings is provided. Apparently, the accompanying drawings are merely for some of the embodiments of the present invention. Any ordinarily skilled person in the technical field of the present invention could still obtain other accompanying drawings without use laborious invention based on the present accompanying drawings.

FIG. 3 is a schematic diagram illustrating a force touch liquid crystal display (LCD) 300 according to one preferred embodiment of the present disclosure.

The force touch LCD 300 includes an LCD module, a shield metal layer 340, a force film 350, and a touch panel (TP) 360. The LCD module may include a thin-film transistor (TFT) substrate 310, a liquid crystal layer 320, and a color filter (CF) substrate 330. The TFT substrate 310, the liquid crystal layer 320, and the color filter (CF) substrate 330 are layered subsequently. The force film 350 can be formed on one surface of the touch panel 360, and this surface, such as the lower surface as shown in FIG. 3, faces the LCD module. Preferably, the force film is formed on the lower surface of the touch panel 360 with a technique such as silk screen printing. The force film 350 can be fabricated from an indium tin oxide (ITO). The force film 350 on the lower surface of the touch panel 360 is patterned with an ITO pattern with a technique like silk screen printing. However, the material for the force film 350 is not limited to ITO; instead, the force film 350 can be fabricated from other kind of transparent conductive material.

The shield metal layer 340 can be arranged on one side of the CF substrate 330, and this side faces the force film 350. In other words, the shield metal layer 340 can be arranged on an upper side of the CF substrate 330 (i.e., an outer side). The shield metal layer 340 can be fabricated by ITO. However, the material for the shield metal layer 340 is not limited to ITO; instead, the shield metal layer 340 can be fabricated from other kind of transparent conductive material.

In the state of the force film 350 facing the LCD module, the touch panel 360 is attached to the LCD module tightly with an adhesive 390 arranged on the periphery of the touch panel 360 so that the touch panel 360 and the LCD module can become an entity. A very thin air layer (or an air gap) is usually spared between the touch panel 360 and the LCD module. More specifically, an air layer is spared between the force film 350 and the shield metal layer 340, and the air layer is used to form a capacitor required for the pressure capacitor.

The adhesive 390 adopts an optical adhesive, such as the optical clear adhesive (OCA) or the core reinforcement (COR) adhesive, but is not limited to these adhesives. Other kinds of adhesives are adoptable as long as the adhesive is characteristic of strong adhesiveness and can satisfy the need to adhere the touch panel to the LCD module tightly without affecting the optical transmittance.

The force film 350 and the shield metal layer 340 can form a pressure capacitor. As FIG. 3 shows, the force film 350 can act as an upper electrode of the pressure capacitor, and the shield metal layer 340 can act as a lower electrode of the pressure capacitor. Thus, an air layer is formed between the force film 350 and the shield metal layer 340. The air layer can act as an insulating medium layer in the middle of the pressure capacitor. Accordingly, a good force touch structure is established.

Rather than using a common voltage electrode 380 in the LCD module as an electrode for the pressure capacitor, the shield metal layer 340 is used as an independent electrode of the pressure capacitor in the force touch structure. Such an arrangement can effectively solve the problem that signal disturbance easily occurs in the related art where the arrangement of a common voltage electrode is used as an electrode for the pressure capacitor. In this way, not only the signal disturbance seldom occurs between force touch and display but also the force touch quality of the force touch LCD is well improved.

The shield metal layer 340 can be used as not only a lower electrode of the pressure capacitor but also a shield layer so the shield metal layer 340 can prevent the LCD display signal from being disturbed by the touch panel signal and vice versa to ensure the accuracy of display and touch.

The force touch LCD 300 can further include a cover 370. The cover 370 is arranged on an outer side of the touch panel 360 and used to protect the touch panel 360 from being affected and hurt because of the external environment. The cover 370 may be a tempered glass cover, a plastic material cover, a polymethylmethacrylate (PMMA) cover, etc.

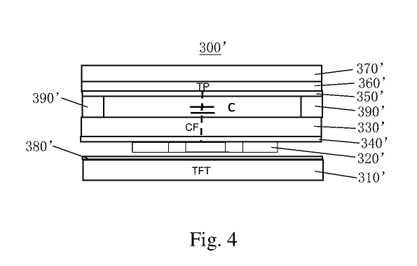

FIG. 4 is a schematic diagram illustrating a force touch liquid crystal display (LCD) 300′ according to another preferred embodiment of the present disclosure.

The difference between the force touch LCD 300′ in this embodiment and the force touch LCD 300 as shown in FIG. 3 is described as follows: A shield metal layer 340′ is arranged on another surface of a color filter (CF) substrate 330′ (i.e., a lower surface as shown in FIG. 4), and this surface of the CF substrate 330′ faces a liquid crystal layer 320′. In FIG. 3 and FIG. 4, similar labels indicate identical or similar components. For example, label 350 and label 350′ both indicate a force film; label 340 and label 340′ both indicates a shield metal layer. To simplify the description, the same or similar parts in this embodiment are skipped.

Refer to FIG. 3 and FIG. 4. A method of fabricating a force touch liquid crystal display (LCD) as mentioned above is detailed. The method includes steps as follows. Form a force film 350 on one surface of a touch panel 360. Layer a thin-film transistor (TFT) substrate, a liquid crystal layer 320, and a color filter (CF) substrate 330 subsequently to form an LCD module. Arrange a shield metal layer 340 on one side of the color filter substrate 330. Face the force film 350 with the LCD module. Attach the touch panel 360 to the LCD module tightly with an adhesive 390 arranged on the periphery of the touch panel 360. Form an air layer between the touch panel 360 and the LCD module.

The shield metal layer 340 is arranged on one side of the CF substrate 330, and this side faces the touch panel 360 (refer to FIG. 3). In another preferred embodiment of the present disclosure, the shield metal layer 340′ is arranged on the other side of the CF substrate 330′, and this side faces the liquid crystal layer 320′ (refer to FIG. 4).

The method of fabricating the force touch LCD further includes a step of arranging a cover 370 on the touch panel 360 (that is, the outer side) to protect the touch panel 360 from being affected because of the external environment such as touch or hit.

The touch function provided by the force touch LCD is realized in as follows: When a human's finger touches the touch panel 360 with different amounts of force, the deformation of the force film 350 changes to different degrees, the distance of the pressure capacitor becomes different as well, and further the pressure capacitor varies. The variation of the capacitor is transformed into the variation of an electric signal. The variation of the electric signal is transmitted to a processor of a touch integrated circuit (IC). The processor locates the touched position and the signal and finally sends a command to perform a specific function of a small- and medium-sized product such as a smartphone, a flat computer, a wearable smart watch, etc.

Based on the force touch LCD proposed by the embodiment of the present disclosure, the signal disturbance which often appears in the related art because of a VCOM ITO used as one electrode for the pressure capacitor in the conventional force touch structure does not occur easily and further the force touch quality improves. In addition to acting as one electrode for the pressure capacitor, the shield metal layer can further act a shield layer so that the shield metal layer can prevent the LCD display signal from being disturbed by the touch panel signal and vice versa to ensure the accuracy of display and touch.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A force touch liquid crystal display (LCD), comprising: a touch panel and a liquid crystal display (LCD) module; the LCD module comprising a thin-film transistor (TFT) substrate, a liquid crystal layer, and a color filter substrate layered subsequently wherein the force touch LCD further comprises:
a force film, formed on a surface of the touch panel, and the surface facing the LCD module; and
a shield metal layer, arranged on a surface of the color filter substrate.

2. The force touch LCD of claim 1, wherein the touch panel is attached to the LCD module tightly with an adhesive arranged on a periphery of the touch panel, and an air layer is formed between the touch panel and the LCD module.

3. The force touch LCD of claim 2, wherein a pressure capacitor is formed between the force film and the shield metal layer; the force film and the shield metal layer form two electrodes of the pressure capacitor, respectively.

4. The force touch LCD of claim 1, wherein the shield metal layer is arranged on the surface of the color filter substrate and the surface faces the force film.

5. The force touch LCD of claim 1, wherein the shield metal layer is arranged on the surface of the color filter substrate and the surface faces the liquid crystal layer.

6. A method of fabricating a force touch liquid crystal display (LCD) comprising:
forming a force film on one surface of a touch panel;
stacking a thin-film transistor (TFT) substrate, a liquid crystal layer, and a color filter substrate subsequently to form an LCD module;
arranging a shield metal layer on one side of the color filter substrate;
arranging the force film to face the LCD module, and attaching the touch panel to the LCD module tightly.

7. The method of claim 6, wherein the touch panel is attached to the LCD module tightly with an adhesive arranged on a periphery of the touch panel, and an air layer is formed between the touch panel and the LCD module.

8. The method of claim 6, wherein a pressure capacitor is formed between the force film and the shield metal layer; the force film and the shield metal layer form two electrodes of the pressure capacitor, respectively.

9. The method of claim 6, wherein the shield metal layer is arranged on the surface of the color filter substrate and the surface faces the force film.

10. The method of claim 6, wherein the shield metal layer is arranged on the surface of the color filter substrate and the surface faces the liquid crystal layer.
